(19) United States
(12) Patent Application Publication
(10) Pub. No.: US 2011/0182540 A1
(43) Pub. Date: Jul. 28, 2011

(54) Sealing Cap

(75) Inventors: Hiroshi Terazawa, Okayama (JP); Takanobu Arakawa, Okayama (JP)

(73) Assignee: Uchiyama Manufacturing Corp., Okayama (JP)

(21) Appl. No.: 13/013,028

(22) Filed: Jan. 25, 2011

(30) Foreign Application Priority Data
Jan. 25, 2010 (JP) 2010-012809

(51) Int. Cl. F16C 33/76; F16J 15/02

(52) U.S. Cl. 384/489; 277/650

(57) ABSTRACT

A sealing cap made of metal adapted to be fitted into an end opening of a cylindrical mechanical member for closing an inner cylindrical portion of the mechanical member. The sealing cap comprises a disk-like cap body and a cylindrical portion integrally extended from a circumferential edge portion of the cap body and fitted under pressure into the end opening of the inner cylindrical portion of the cylindrical mechanical member. The cap body includes an inclined surface portion whose diameter is gradually reduced toward inner side of the inner cylindrical portion of the cylindrical mechanical member.

### TECHNICAL FIELD

The present invention relates to a metal sealing cap provided at an open end of a cylindrical mechanical member for closing an inner cylindrical portion of the cylindrical mechanical member, and more specifically to a sealing cap provided at an open end of an outer ring member of a roll bearing unit rotatably supporting a driven wheel of an automobile.

### BACKGROUND ART

One example of such a roll bearing unit rotatably supporting the driven wheel of an automobile is described in JP-2006-112583-A (referred as Patent Literature 1). The roll bearing unit shown in the Patent Literature 1 comprises an outer ring member fixed to an automobile body, an inner ring and a hub ring rotatably supported to the outer ring member via plural rows of rolling bodies, and a seal ring sealing a bearing space. The hub ring is fitted and inserted to the outer ring member while interposing the rolling bodies and the inner ring from the outer side (outer side of the automobile body), and the tip end portion of the inner side of the hub ring (inner side of the automobile body) is caulked to be integrated with the inner ring. A flange portion is formed at the outer side of the hub ring and a wheel is fixed to the flange portion. The outer ring member is formed in the shape of cylindrical with both ends opened and the open end on the inner side is caulked as mentioned above, then the end is provided with a metal cover member (the sealing cap) under pressure for closing the inner cylindrical portion. The cover member prevents invasion of dirt and dust from outside into the bearing space including an orbit portion of the rolling bodies, thereby achieving prevention of damage of the rolling bodies and the orbit surface by the dirt and dust.

JP-2008-196553-A (referred as Patent Literature 2) discloses an installation structure of a bore plug (cap) used for sealing a bore of a mechanical member such as a shaft bore of a differential gear of an automobile transmission. According to the installation structure of the bore plug in the Patent Literature 2, a peripheral circular portion (cylindrical portion) constituting a plug body like Petri dish has a projection to be engaged, and an engagement groove extending in a circumferential direction is formed on the inner circumferential surface formed in the bore of a housing. The closed attachment condition of the bore plug to the bore is kept by engaging the projection to be engaged to the engagement groove.

Furthermore, Japanese Patent NO. 3036820 (referred as Patent Literature 3) discloses a sealing device for separating the axial bore of a sprocket shaft and a shift transmission shaft. The sealing device of the Patent Literature 3 has a sealing cap like Petri dish as mentioned above provided at a sealing bore of the axial bore for airtightly sealing thereof. The inserting portion of the sealing bore has a small diameter, on the other hand, the rear portion of the sealing cap in its inserting direction is made large. When the cap is attached on the sealing bore, the large diameter portion is compressed to be passed through the inserting portion and is enlarged and engaged in an engaging bore (circumferential groove) adjacent to the inserting portion, then the cap is restrained by the snap engagement.

### SUMMARY OF INVENTION

### Technical Problem

According to the structure of the bearing unit as shown in Patent Literature 1, the temperature in the bearing space increases and its inner pressure becomes high accompanied with rotation of a hub ring and an inner ring. In Patent Literature 1, a cover member has a bore for mounting a rotary detection unit and the inner pressure applied on the cover member does not become so high. However, when the end of an outer ring member is completely closed with such a cover member without a bore, the inner pressure acts on the cover member to push out thereof. Specifically, such a cover member has a larger area applied with the inner pressure comparing to the seal ring sealing the bearing space and the inner pressure is largely acted, then the cover member might be slipped off the outer ring member. In Patent Literature 1 a resin seal is airtightly attached so as to bridge a peripheral edge portion of the cover member and the open end of the outer ring member. Such a resin seal does not have a function of preventing slipping off the cover member by the inner pressure.

When the engaging means of the engaging groove and the projection to be engaged is applied to a fitting portion of the cover member to the outer ring member, it is effective for preventing slipping off the cover member caused by the inner pressure. However, the projection to be engaged may damage the inner circumferential surface (inner diameter surface) of the outer ring when the cover member is attached, so that it is not enough to provide such engaging means. When the restraining means of the cap is applied to the fitting portion of the cover member to the outer ring member by the snap engagement as disclosed in Patent Literature 3, it is also effective for preventing the cover member from slipping out by the inner pressure. However, the case is not preferable because the large diameter portion is compressed and deformed when the cover member is attached and then the inner circumferential surface of the outer ring member is damaged.

The present invention is made in view of the above-mentioned problems and has an object to provide a sealing cap which is attached on an open end of a cylindrical mechanical member without damaging the open end and stably keeps the attaching condition without slipping off when the inner pressure of the cylindrical mechanical member increases after attachment.

### Solution to Problem

According to a sealing cap made of metal adapted to be fitted into an end opening of a cylindrical mechanical member, for closing an inner cylindrical portion of the mechanical member, the sealing cap comprises a disk-like cap body and a cylindrical portion integrally extended from a circumferential edge portion of the cap body and fitted under pressure into the end opening of the inner cylindrical portion of the cylindrical mechanical member. The cap body includes an inclined surface portion whose diameter is gradually reduced into the axial direction of the inner cylindrical portion of the cylindrical mechanical member. According to the sealing cap, the inclined surface portion may have the largest diameter at the circumferential edge portion of the cap body where an extended base portion of the cylindrical portion is formed. In addition, the cylindrical portion may be integrally provided in its peripheral portion with an elastic annular body intervening in compressed condition between the peripheral portion and the inner cylindrical portion of the mechanical member along its circumferential direction. Still further, the mechanical member is constituted as an outer ring member of a roll bearing unit and it may be fitted under pressure into the inner cylindrical portion of the outer ring member to close the inner cylindrical portion.

### Effects of Invention

The present invention comprises the disk-like cap body and the cylindrical portion integrally formed from the circumferential edge portion of the cap body. The cylindrical portion is fitted under pressure to the inner cylindrical portion of the cylindrical mechanical member from the open end of the mechanical member, thereby being attached to the open end of the cylindrical mechanical member and closing the inner cylindrical portion of the cylindrical mechanical member. The cap body includes the tapered portion the diameter of which is gradually reduced into the inside of the inner cylindrical portion of the mechanical member, so that when the inner pressure in the inner cylindrical portion of the mechanical member increases after attachment, the inner pressure acting on the cap body is exerted so as to push out the cylindrical portion into the centrifugal direction from the largest diameter portion of the tapered portion. Therefore, the fitting force of the cylindrical portion and the inner cylindrical portion of the mechanical member is enhanced by the enlarging force of the diameter of the cylindrical portion by such action. Even if the inner pressure in the mechanical member increases, the slip-off prevention effect of the sealing cap is effectively achieved. In addition, the sealing cap is attached to the mechanical member by the press-fit to the inner cylindrical portion of the cylindrical portion, so that there is no fear of causing damages on the fitting surfaces of them.

When the largest diameter portion of the tapered portion is the circumferential edge portion of the cap body and is also formed as an extended base portion of the cylindrical portion, the point from which the enlarging force of the diameter of the cylindrical portion accompanied with increase of the inner pressure accords with the extended base portion of the cylindrical portion. Accordingly, the action of enlarging the diameter of the cylindrical portion is directly exerted and the fitting force as mentioned above is effectively achieved.

When the elastic annular body is integrally provided at the peripheral portion of the cylindrical portion along the circumferential direction, in case that the cylindrical portion of the sealing cap is fitted under pressure to the inner cylindrical portion of the cylindrical mechanical member, the elastic annular body is interposed in compressed condition with the inner cylindrical portion of the mechanical member, thereby keeping the fitting surfaces of the inner cylindrical portion of the mechanical member and the cylindrical portion of the sealing cap inaccurate sealing condition. Therefore, the inner cylindrical portion of the mechanical member and the exterior are surely blocked and the inner cylindrical portion is not adversely affected from the exterior, thereby keeping an intended function of the mechanical member for a long time.

When the mechanical member is the outer ring member of the roll bearing unit, the inner pressure in the bearing space surrounded with the outer ring members increases when the bearing unit is operated. However, when the sealing cap of the present invention is provided at the open end of the outer ring member, it endures such inner pressure, and there is no fear of unexpected situation such that the sealing cap is slipped off. In addition, when the cylindrical portion of the sealing cap is fitted under pressure to the inner cylindrical portion (inner diameter portion) of the outer ring member, the inner diameter surface of the outer ring member is not damaged.

### BRIEF DESCRIPTION OF DRAWINGS

FIG. 1 is a vertical sectional view showing one example of a bearing unit equipped with a sealing cap of one embodiment of the present invention.

FIG. 2a is a diagrammatic view showing behavior principle of a sealing cap when pressure as shown with an outlined arrow is applied, and FIG. 2b and FIG. 2c show the similar views in reference examples, respectively.

FIG. 3a, FIG. 3b, FIG. 3c and FIG. 3d are sectional views showing modified examples of the sealing cap.

FIG. 4a and FIG. 4b are sectional views showing other modified examples of the sealing cap.

FIG. 5a and FIG. 5b are enlarged sectional views of a main portion of a sealing cap according to other embodiment of the present invention.

### EMBODIMENTS TO EXECUTE INVENTION

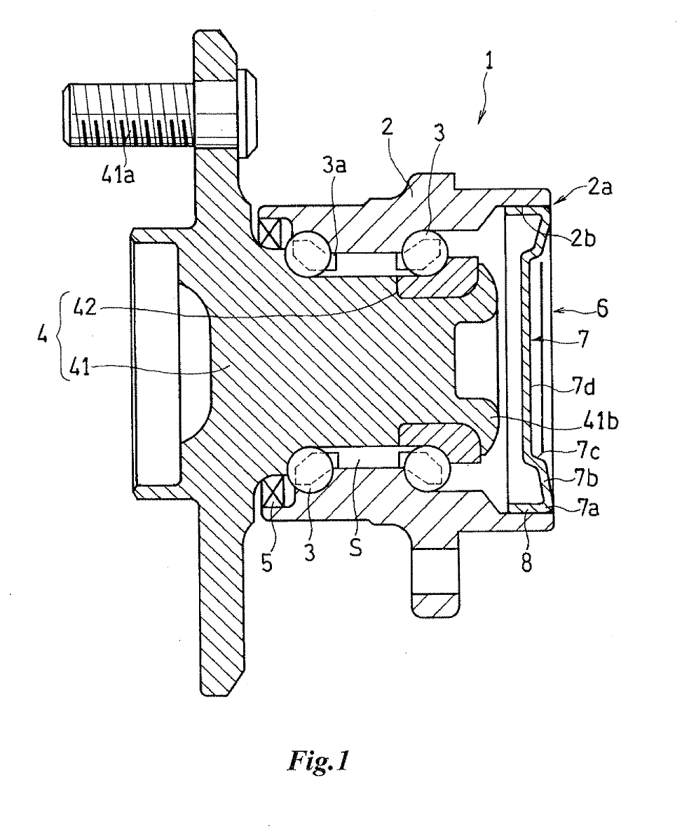

Now, preferred embodiments of the present invention are explained based on the drawings. FIG. 1 shows a bearing unit rotatably supporting a driven wheel of an automobile. In the bearing unit 1 in the figure, a hub ring 41 and an inner ring member 42 are supported in an axially rotatable condition to the inner diameter portion of the outer ring member (cylindrical mechanical member) 2 fixed to the automobile body (not shown) via two rows of rolling bodies (ball) 3. A driven wheel (tire wheel), not shown, is attached to the hub ring 41 with a bolt 41a. The hub ring 41 and the inner ring member 42 constitute an inner ring 4 which is to be a rotary side and the rolling bodies 3 are interposed while being held with a retainer 3a between the outer ring member 2 and the inner ring 4. A seal ring (oil seal) 5 of an axial seal type is provided between the wheel ends of the outer ring member 2 and the inner ring 4 along the axial direction of the hub ring 41 while keeping a mutual slidably contacting condition. The sealing cap 6, to be mentioned later, is fitted to the end portion on the automobile body side of the outer ring member 2, thereby constituting an angular type roll bearing unit 1. The space between the outer ring member 2 and the inner ring 4 and divided by the seal ring 5 and the sealing cap 6 constitutes a bearing space S including orbit surfaces of the rolling bodies 3 and leakage of lubricant grease filled in the bearing unit S and invasion of dirty water and dust are prevented by the combination of the seal ring 5 and the sealing cap 6.

The inner ring member 42 is fitted to the hub ring 41 from the automobile body side and the automobile body side end 41b of the hub ring 41 is enlarged and caulked, thereby preventing slip-off and applying pre-load on the bearing. For this purpose, the automobile body side end of the outer ring member 2 is opened and the open end 2a of the outer ring member 2 is fitted with the sealing cap 6 after being fitted with the inner ring member 42, thereby preventing invasion of dust and dirty water into the fitting portion (bearing space S) between the outer ring member 2 and inner ring 4 via the rolling bodies 3. The sealing cap 6 comprises the disc-like cap body 7 and the cylindrical portion 8 which is integrally formed with the circumferential edge portion 7a of the cap body 7 and is fitted under pressure to the inner cylindrical portion 2b of the outer ring member 2 from the open end 2a of the outer ring member 2. The cylindrical portion 8 is formed such that it forms an extended base portion at the circumferential edge portion 7a of the cap body 7 and is bent in the insertion direction under pressure into the outer ring member 2. The outer diameter of the cylindrical portion 8 is designed to be a little larger than the inner diameter of the inner cylindrical portion 2b of the outer ring member 2 in a manner such that metal members can be fitted under pressure. Accordingly, when the cylindrical portion 8 is fitted to the inner cylindrical portion 2b of the outer ring member 2 under pressure, there is no fear of damaging the fitting surfaces thereof.

The cap body 7 includes a tapered portion 7b the diameter of which is gradually reduced into the inside of the inner cylindrical portion 2b of the outer ring member 2. The largest diameter portion of the tapered portion 7b of the cap body 7 in FIG. 1 is the circumferential edge portion 7a, which constitutes an extended base portion of the cylindrical portion 8. In addition, a second tapered portion 7c having a large inclined angle is formed at the smallest diameter portion of the tapered portion 7b so as to reduce its diameter into the inside of the inner cylindrical portion 2b, the inner side of which is formed to be connected with a flat bottom portion 7d. Thus formed sealing cap 6 can be obtained by sheet-metal working and drawing working of a steel plate like stainless steel or SPCC.

Such a bearing unit 1 is used for a driven wheel of an automobile as mentioned above. Namely, the outer ring member 2 is fixed to the automobile body and a wheel is attached to the hub ring 41. The driven wheel is rotated together with the inner ring 4 when the automobile runs. The inner ring 4 is rotatably supported to the outer ring member 2 via the rolling bodies 3, thereby smoothly executing such rotation. A lubricant agent filled in the bearing space S runs into the space between the rolling bodies 3 and the orbit surface of the outer ring member 2 and between the rolling bodies 3 and the orbit surface of the inner ring 4, so that rotation is further smoothly executed in a low friction condition. Friction heat of each portion is accumulated while keeping rotation, the temperature in the bearing space S increases, and a portion of the lubricant agent evaporates, thereby increasing the air pressure (inner pressure) in the bearing space S. This inner pressure exerts in such a direction to slip the sealing cap 6 off the outer ring member 2 (in right direction on the sheet of FIG. 1, namely in opposite direction of press-fit). Specifically, the cap body 7 of the sealing cap 6 has a large area because of the structural feature of the outer ring member 2, the inner pressure applied on the sealing cap 6 becomes larger than that on the seal ring 5, so that there is a fear of slip-off. However, such a fear of slip-off can be swept away by using the sealing cap 6 as constructed in the figure.

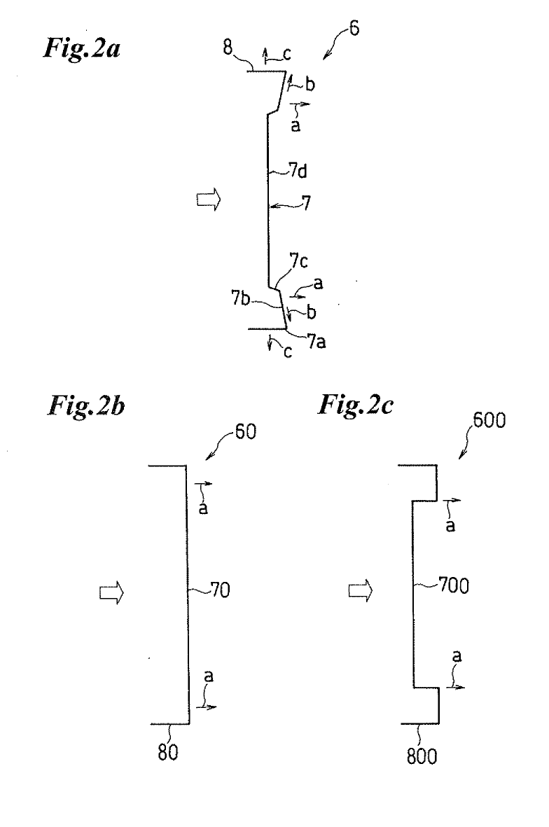

FIG. 2a diagrammatically shows the principle that the fear of slipping-off of the outer ring member 2 is swept away by the structural feature of the sealing cap 6. FIG. 2b and FIG. 2c are reference examples for comparing to FIG. 2a. In FIG. 2a, the inner pressure is exerted on the sealing cap 6 in a direction shown with an outlined arrow (direction along the rotary axis center of the outer ring member 2 and the inner ring 4), the force for displacing the cap body 7 into an arrow “a” is added. In this case, the force in the direction “a” acts as a component force of an arrow “b” direction along the tapered portion 7b, is converted into a force so as to push out the cylindrical portion 8 into the centrifugal direction via the extended base portion (circumferential edge portion 7a), thereby increasing the fitting force of the cylindrical portion 8 to the outer ring member 2. When the largest diameter portion of the tapered portion 7b is formed as the extended base portion of the cylindrical portion 8, the component force along the arrow “b” acts as a force to push out the cylindrical portion 8 in the centrifugal direction, thereby remarkably achieving the reinforcing action of the fitting force. The embodiment in the figure also has the second tapered portion 7c, the component force along the second tapered portion 7c is applied, thus the force for pushing out the cylindrical portion 8 into the centrifugal direction is encouraged. Accordingly, the fitting force of the cylindrical portion 8 to the outer ring member 2 is further reinforced even when the inner pressure increases, so that there is no fear of slip-off of the sealing cap 6 from the outer ring portion 2.

On the other hand, when sealing caps 60, 600 have cap bodies 70, 700 constituted with only the surfaces orthogonal to or parallel to the direction shown with the outlined arrow (as mentioned above) as shown in the reference examples of FIG. 2b and FIG. 2c, the force into the direction of the arrow “a” is only applied on the cap bodies 70, 700 and the force to push out the cylindrical portions 80, 800 into the centrifugal direction is not caused. Therefore, when the inner pressure increases, the force (force in the direction of the arrow “a”) in a direction to slip the sealing caps 60, 600 off the outer ring member 2 (refer to FIG. 1) is reinforced. When this force becomes larger than the fitting force of the cylindrical portions 80, 800 and the outer ring member 2, the sealing caps 60, 600 slip off.

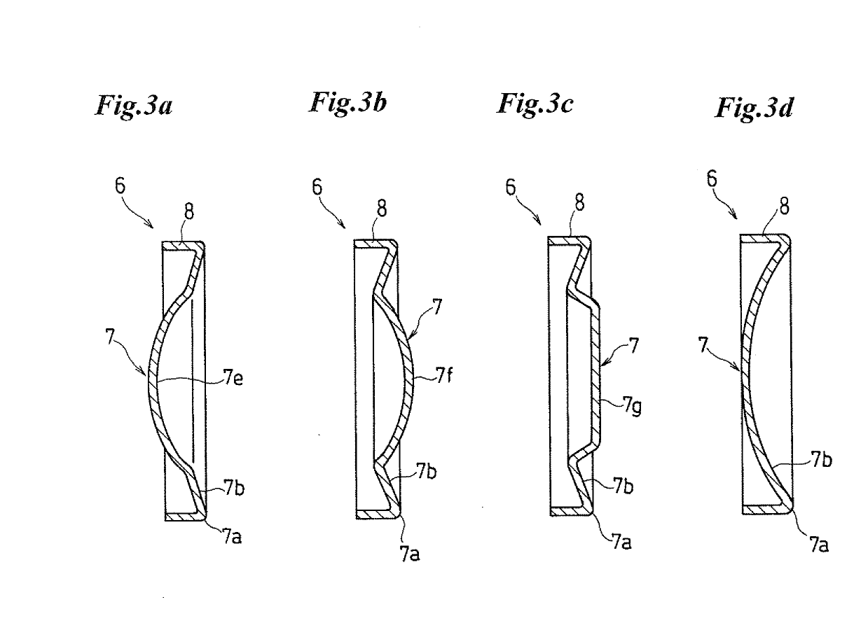

FIG. 3a, FIG. 3b, FIG. 3c, and FIG. 3d show various modified embodiments of the sealing cap 6. The sealing cap 6 in these four embodiments comprises the cap body 7 and the cylindrical portion 8 integrally formed at the circumferential edge portion 7a of the cap body 7 so as to be directed to the press-fit direction, as mentioned above. The largest diameter portion of any cap body 7 is the circumferential edge portion 7a and the cap body 7 includes the tapered portion 7b the diameter of which is gradually reduced into the inside of the inner cylindrical portion 2b of the outer ring member 2. In the embodiment of FIG. 3a, a curved bottom portion 7e denting toward the inside of the inner cylindrical portion 2b of the outer ring member 2 is extended from the smallest diameter portion of the tapered portion 7b. In the embodiment of FIG. 3b, a convex push-up bottom portion 7f into the outward (opposite to press-fit direction) of the inner cylindrical portion 2b of the outer ring member 2 is extended from the smallest diameter portion of the tapered portion 7b. In the embodiment of FIG. 3c, a trapezoidal push-up bottom portion 7g into the outward (opposite to press-fit direction) of the inner cylindrical portion 2b of the outer ring member 2 is extended from the smallest diameter portion of the tapered portion 7b. In the embodiment of FIG. 3d, the whole cap body 7 is curved and dent into the inside of the inner cylindrical portion 2b of the outer ring member 2 and vicinity along the inside of the circumferential edge portion 7a is substantially formed as the tapered portion 7b.

The sealing cap 6 in any one of FIG. 3a, FIG. 3b, FIG. 3c and FIG. 3d is attached to the open end 2a of the outer ring member 2 applied with the inner pressure as shown in FIG. 1. Such attachment is achieved by fitting under pressure the cylindrical portion 8 to the inner cylindrical portion 2b of the outer ring member 2. Accordingly, when the inner pressure in the bearing space S increases under such attached condition, the fitting force of the cylindrical portion 8 and the outer ring member 2 is reinforced by the tapered portion 7b, as mentioned above, and the sealing cap 6 does not slip off the outer ring member 2.

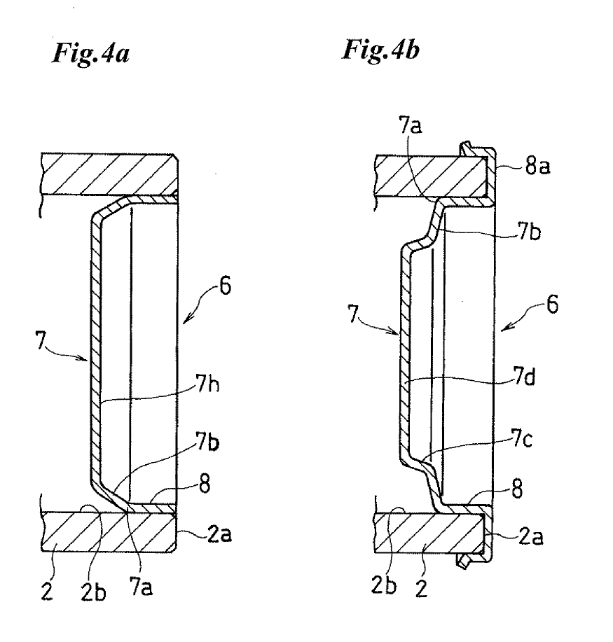

FIG. 4a and FIG. 4b show other embodiments of the sealing cap 6. These embodiments are different from the above-mentioned embodiments in that the cylindrical portion 8 is extended in a direction opposite to press-fit direction (opposite to that of the above-mentioned embodiments) from the circumferential edge portion 7a of the cap body 7. The largest diameter portion of the cap body 7 in these embodiment is the circumferential edge portion 7a and the cap body 7 include the tapered portion 7b the diameter of which is gradually reduced into the inside of the inner cylindrical portion 2b of the outer ring member 2. In the embodiment of FIG. 4a, a flat bottom portion 7h is further extended from the smallest diameter portion of the tapered portion 7b. In the embodiment of FIG. 4b, the second tapered portion 7c and the flat bottom portion 7d are extended from the smallest diameter portion of the tapered portion 7b similar to the embodiment in FIG. 1. In addition, in the embodiment of FIG. 4d, an annular enclosing portion 8a having a sectional shape of the letter “U” is integrally formed with the cylindrical portion 8 at the end portion of the cylindrical portion 8 opposite to the press-fit direction (opposite to the extended base portion). The enclosing portion 8a is designed to enclose the open end 7a when the cylindrical portion 8 is fit under pressure to the outer ring member 2 and the sealing cap 6 is attached to the open end 7a. Therefore, the sealing cap 6 can be stably attached to the outer ring member 2 and dirt and dust can be further prevented from entering the bearing space S.

The sealing caps 6 of FIG. 4a and FIG. 4b are also attached to the open end 2a of the outer ring member 2 applied with the inner pressure as shown in FIG. 1. Such attachment is achieved by fitting under pressure the cylindrical portion 8 to the inner cylindrical portion 2b of the outer ring member 2. Accordingly, when the inner pressure in the bearing space S increases under such fitted condition, the fitting force of the cylindrical portion 8 and the outer ring member 2 is reinforced by the tapered portion 7b, and the sealing cap 6 does not slip off the outer ring member 2, as mentioned above.

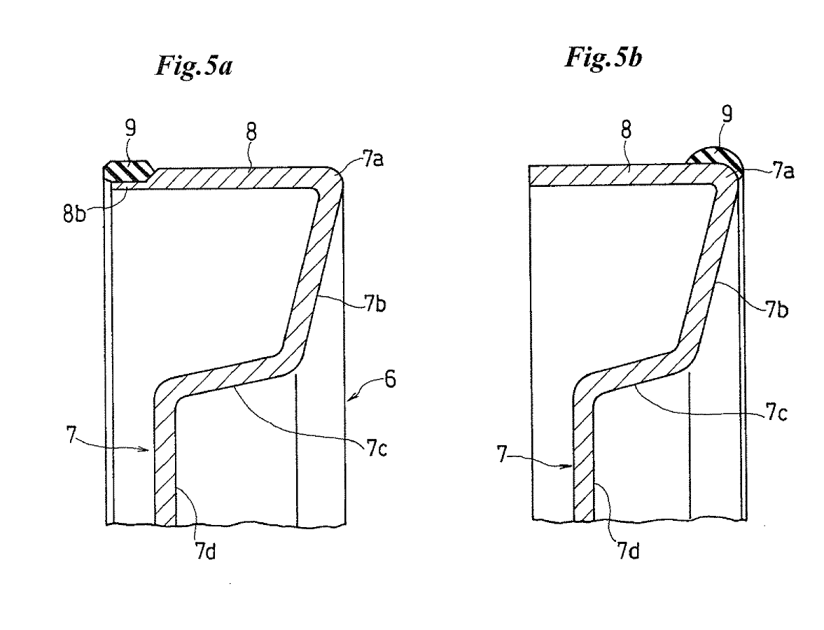

FIG. 5a and FIG. 5b are enlarged views of the essential portion showing a sealing cap according to other embodiment of the present invention. These two embodiments are characterized in that an elastic annular body 9 which can be interposed in compressed condition with the inner cylindrical portion 7b of the outer ring member 2 is integrally provided at the peripheral portion of the cylindrical portion 8 of the sealing cap 6 of the embodiment in FIG. 1 along the circumferential direction. The elastic annular bodies 9 in the figures are made of rubber molded bodies and are integrally formed with the sealing caps 6 by vulcanization. In FIG. 5a, the elastic annular body 9 is integrally fixed to a step portion 8b formed on the peripheral portion at the tip end in press-fit direction of the cylindrical edge portion 8. In FIG. 5b, the elastic annular body 9 includes the extended base portion (circumferential edge portion 7a) of the cylindrical portion 8 and is integrally fixed to the peripheral portion of the cylindrical portion 8.

The sealing caps 6 in FIG. 5a and FIG. 5b are also attached to the open end 2a of the outer ring member 2 applied with the inner pressure as shown in FIG. 1. Such attachment is achieved by fitting under pressure the cylindrical portion 8 to the inner cylindrical portion 2b of the outer ring member 2. In case of such fitting and attaching, the elastic annular body 9 is attached while being compressed and elastically deformed, and the elastic reaction force is acted on the fitting surfaces of the cylindrical portion 8 and the outer ring member 2, thereby keeping considerably good sealing ability therebetween. Also in this case, when the inner pressure in the bearing space S increases, the force to push out in the centrifugal direction is applied on the cylindrical portion 8, thereby reinforcing the fitting force. Such force is also applied on the interposed elastic annular body 9 and the sealing ability is further increased. The form and the position of the elastic annular body 9 are not limited to those shown in the figures, and the examples of FIG. 3a FIG. 3d and FIG. 4a and FIG. 4d do not exclude the existence of the elastic annular body 9.

This embodiment shows that the sealing cap 6 of the present invention is attached to the outer ring member 2 of an angular type roll bearing unit 1 for rotatably supporting the driven wheel of the automobile. However, the present invention is not limited to such embodiment and can be widely applied to a sealing cap for closing the open end of the other bearing unit for automobiles and the cylindrical mechanical member of the industrial machinery in which the inner pressure fluctuates. Furthermore, the shape of the sealing cap 6 is not limited to those shown in the figures and the same functions can be achieved as long as the cap has a disk-like cap body including a tapered portion the diameter of which is gradually decreased into the inside of the inner cylindrical portion of the mechanical member.

1. A sealing cap made of metal adapted to be fitted into an end opening of a cylindrical mechanical member, for closing an inner cylindrical portion of the mechanical member, said sealing cap comprising:
a disk-like cap body; and
a cylindrical portion integrally extended from a circumferential edge portion of said cap body and fitted under pressure into said end opening of said inner cylindrical portion of said cylindrical mechanical member; wherein:
said cap body includes an inclined surface portion whose diameter is gradually reduced toward inner side of said inner cylindrical portion of said cylindrical mechanical member.

2. The sealing cap as set forth in claim 1, wherein said inclined surface portion has the largest diameter at the circumferential edge portion of said cap body where an extended base portion of said cylindrical portion is formed.

3. The sealing cap as set forth in claim 1, wherein said cylindrical portion is integrally provided in its peripheral portion with an elastic annular body intervening in compressed condition between said peripheral portion and said inner cylindrical portion of said mechanical member along its circumferential direction

4. The sealing cap as set forth in claim 1, wherein said mechanical member is an outer ring member of a roll bearing unit.

5. The sealing cap as set forth in claim 2, wherein said cylindrical portion is integrally provided in its peripheral portion with an elastic annular body intervening in compressed condition between said peripheral portion and said inner cylindrical portion of said mechanical member along its circumferential direction

6. The sealing cap as set forth in claim 2, wherein said mechanical member is an outer ring member of a roll bearing unit.

7. The sealing cap as set forth in claim 3, wherein said mechanical member is an outer ring member of a roll bearing unit.

8. The sealing cap as set forth in claim 5, wherein said mechanical member is an outer ring member of a roll bearing unit.
